(19) United States
(12) Patent Application Publication
(10) Pub. No.: US 2001/0004860 A1
(43) Pub. Date: Jun. 28, 2001

(54) Saw blade

(75) Inventors: Jorg H. Kullmann, Spangenberg (DE); Manfred Fluhrer, Spangenberg (DE)

Correspondence Address: George M. Thomas, Thomas, Kayden, Horstemeyer & Risley, LLP, Suite 1750, 100 Galleria Parkway N.W., Atlanta, GA, 30339-5948, US

(73) Assignee: Wilhelm H. Kullmann

(21) Appl. No.: 09/749,098

(22) Filed: Dec. 27, 2000

(30) Foreign Application Priority Data
Dec. 28, 1999 (DE) 199 63 396.7

(51) Int. Cl. B27B 33/02

(52) U.S. Cl. 83/846; 83/848; 83/851

(57) ABSTRACT

A saw blade includes a body (1) being formed symmetrically about a longitudinal center plane (8). A plurality of spaced apart unset teeth is formed symmetrically along the longitudinal center plane of the body in at least one recurring cycle of teeth. The at least one recurring cycle of teeth includes at least one first group of teeth and at least one second group of teeth. The at least one first group of teeth includes at least two first teeth (2). The height of one first tooth (2) is different than the height of one other first tooth (2). The width of one first tooth (2) is different than the width of one other first tooth (2). The at least two first teeth (2) each include at least one effective cutting edge (5) having at least one phase (7). The at least one second group of teeth includes at least two second teeth (2*). The heights of the second teeth (2*) are approximately identical and the widths of the second teeth (2*) are approximately identical. The common height of the second teeth (2*) is less than the smallest height of the first teeth (2) and the common width of the second teeth (2*) is more than the greatest width of the first teeth (2). The at least two second teeth (2) each include one effective cutting edge (5*) having a width and being designed to be continuous and straight along its width.

### CROSS REFERENCE TO RELATED APPLICATIONS

This application claims the benefit of co-pending German Patent Application No. 199 63 396.7 entitled “Sägeblatt mit einem Grundkörper und ungeschränkten Zähnen”, filed on Dec. 28, 1999.

### FIELD OF THE INVENTION

The present invention generally relates to a saw blade having a body and a number of unset teeth being arranged symmetrically with respect to a longitudinal center plane of the body. The teeth include cutting edges for cutting a work piece. More particularly, the present invention relates to a saw blade including a plurality of spaced apart teeth being arranged at the body in at least one recurring cycle of teeth including two different groups of teeth. The invention may be applied at a band saw blade, meaning a saw blade having a linear arrangement of the teeth one after the other, and also at a hack saw blade or at a disk saw blade.

### BACKGROUND OF THE INVENTION

It is important to realize that a difference has to be made between the number of teeth in a group and the number of teeth in a recurring cycle of teeth. A group of teeth is to be understood as to include all teeth being associated with one another in terms of at least one common criterion, for example the grading of heights and the grading of widths. A cycle of teeth is to be understood as to include all teeth being associated with one another in terms of all criterions, for example features, and when the order of teeth recurs exactly. The number of teeth in a group may be identical or different compared to the number of teeth in a cycle. The teeth of the saw blade may be arranged at the body with a constant pitch, meaning at an equal distance, or with a variable pitch.

A saw blade is known from U.S. Pat. No. 5,477,763. The effective cutting edges of all teeth include an inner section extending approximately perpendicular to the longitudinal center plane of the body and two inclined phases being connected to both sides of the inner section and extending in a direction towards the body. The widest tooth in the group encloses an angle of more than 90 degrees between the phase and the flank. In case of a constant pitch and although the teeth have a similar design, the grading in heights and the grading in widths of the teeth in the group provides for reduced sensitivity with respect to vibrations and great straight movement of the stabilized band without the danger of substantial undesired lateral movements.

The known saw blade includes at least two groups of teeth preferably being uniformly intermixed. The teeth of the second group all have the same design, and they are wider and smaller than the other teeth. Consequently, the cycle of teeth includes two distinguishable groups of teeth that are intermixed. It is preferred to arrange the teeth to be uniformly intermixed. In case of such a uniform intermixed arrangement, a first group may, for example, include three teeth having such a grading in heights and widths that the height decreases and the width increases if one compares a first tooth with the adjacent tooth. The first group of teeth mainly serves to deepen the cutting channel. The second group of teeth may include three identical teeth, each tooth having a high being less than the height of the third tooth of the first group, each tooth having a width being more than the width of the third tooth of the first group. The second group of teeth serves to improve the surface quality of the cutting channel. The two groups of teeth are intermittently and uniformly arranged in a way that a respective order of teeth in the cycle results. For reasons of simplicity, it is now assumed that a constant pitch is used. Consequently, six teeth are arranged in the cycle. This intermixed arrangement of the groups in the cycle in combination with the necessarily present feed provides for the special advantage of the teeth of the first group removing comparatively thicker chips from the cutting channel and the teeth of the second group removing comparatively thinner chips from the cutting channel. When comparatively thick chips are removed from the cutting channel, wear and tear occurring at the effective cutting edge do not have such a negative effect as it is the case when extremely thin chips are removed from the cutting channel. A greater number of teeth of the second group having the greatest widths provides for the improved surface quality prevailing in the cutting channel. However, a non-uniformly intermixed arrangement of five teeth 1, 2, 3, 4, 5 of the first group with respect to two teeth 6 of the second group in the order 1, 2, 3, 6, 4, 5, 6 in the cycle is possible. The number of teeth in the first group should at least be two. The number of teeth in the second group should at least be two. Usually, the number of teeth in the first group equals the number of teeth in the second group. In this way, it is possible to subject all teeth in the first group to the same forces, and to subject all teeth of the second group to the same forces. However, the stress of the teeth of the second group is different from the stress of the teeth of the first group. It is important to realize that this arrangement is different from the known method of precut and a recut at circular saw blades only using two types of teeth, namely the precutting teeth and the recutting teeth.

Another saw blade is known from U.S. Pat. No. 4,958,546. The saw blade includes teeth being arranged in recurring cycles. Each cycle also forms a group of teeth in a way that the number of teeth in each cycle equals the number of teeth in each group. The teeth in the group and in the cycle, respectively, are distinguished with respect to a guiding tooth, meaning the first tooth or a plurality of first teeth in a cycle or in a group, and with respect to the following teeth. The one guiding tooth or the plurality of guiding teeth is mostly designed as an unset tooth, whereas the following teeth are mostly designed as set teeth. All teeth usually have the same width. The guiding tooth has the greatest height, and the heights decrease within the group. The guiding tooth is sometimes inclined in a way to include a phase, or its cutting edge includes a channel for breaking chips. Usually, the set following teeth are set alternately to the right and to the left to cause the cutting channel to be wider than the body of the saw blade. In case two guiding teeth are present, they may be designed to be graded in heights as it is the case in known precutting teeth and recutting teeth of a circular saw blade, the effective cutting edge being distributed over the two guiding teeth. The cycle of teeth is completed with the set following teeth widening the cutting channel. Usually, the decrease in heights of the teeth is realized in steps one after the other. Embodiments having different teeth with respect to their heights are known, but they are irregularly arranged in the cycle. In one embodiment that is not illustrated, there are seven teeth. The guiding tooth is unset, and it includes a straight cutting edge extending over the width of the body. Three pairs each including two following teeth are arranged after the guiding tooth, all following teeth being designed as set teeth. The following teeth are alternately set to the left and to the right. The two last pairs of following set teeth may have an identical set width in combination with the same or a different height. Consequently, these four last following teeth define the width of the cutting channel, and they alternately contact the two faces of the cutting channel. For example, the fifth tooth and the seventh tooth of the group consisting of seven teeth form the surface of the cutting channel. The seventh tooth fulfills a process step serving to later compensate for the progression of the fifth tooth. The known saw blade requires a great expenditure of manufacture.

### SUMMARY OF THE INVENTION

The present invention relates to a saw blade. The saw blade includes a body being formed approximately symmetrically about a longitudinal center plane. A plurality of spaced apart unset teeth is formed approximately symmetrically along the longitudinal center plane of the body in at least one recurring cycle of teeth. The at least one recurring cycle of teeth includes at least one first group of teeth and at least one second group of teeth. The at least one first group of teeth includes at least two first teeth each having a height and a width. The height of one first tooth is different than the height of one other first tooth. The width of one first tooth is different than the width of one other first tooth. The at least two first teeth each include at least one effective cutting edge having at least one phase. The at least one second group of teeth includes at least two second teeth each having a height and a width. The heights of the second teeth are approximately identical and the widths of the second teeth are approximately identical. The common height of the second teeth is less than the smallest height of the first teeth and the common width of the second teeth is more than the greatest width of the first teeth. The at least two second teeth each include one effective cutting edge having a width and being designed to be continuous and straight along its width.

The novel saw blade is inexpensive in manufacture, and it provides improved surface quality in the cutting channel.

In the novel saw blade, the teeth of the two groups have substantially different designs. The teeth of the first group include phases. The teeth of the second group do not include phases. This means that the teeth of the second group have a cutting edge extending straight and continuously over the width.

The cutting edges of the first teeth of the first group including phases require approximately three times grinding for their manufacture. The cutting edges of the teeth of the second group not including phases may be produced by grinding only one time. Consequently, the cost of manufacture of the second teeth of the second group is substantially reduced. None of the ground cutting edges works over the entire ground width, meaning that parts of the ground surface are not used. Although the teeth of the second group do not include a phase, the teeth of the second group work side by side with the teeth of the first group.

The order of the teeth in the first group may be freely chosen. That recurring cycle of teeth includes at least two distinguishable groups of teeth. The groups of teeth are not arranged one after the other, but rather in an intermixed fashion. This “overlapping design” of the groups of teeth may especially be regular. For example, a first group may include three teeth having heights decreasing in the moving direction of the band saw blade or against the moving direction of the band saw blade and widths increasing. This first group of the three teeth substantially serves to deepen the cutting channel in the work piece. The second group of teeth may include three teeth of the same dimension that do not include phases. The second teeth have a height being less than the height of the third and smallest tooth of the first group and a width being more than the width of the third and widest tooth. The second group of teeth serves to improve the surface quality of the cutting channel in the work piece. The two groups of teeth are arranged in a way to they are uniformly intermixed. Assuming that the teeth are arranged at the body of the band saw blade at a constant pitch, meaning at a constant distance, there are six intermixed teeth in the cycle. The intermixed design or the overlapping design of the groups of teeth in the cycle together with a necessarily present advance or feed provides for the advantage of the teeth of the first group removing comparatively thicker chips from the cutting channel and the teeth of the second group removing comparatively thinner chips from the cutting channel. When comparatively thicker chips are removed from the cutting channel, wear and tear do not have such a negative effect on the effective cutting edge as it is the case with extremely thin chips. The plurality of second teeth in the second group having the greatest width provides for an improved surface quality in the cutting channel. The increased number of second teeth results in wear and tear being reduced and in the usable time of the saw blade being increased.

The novel saw blade differs substantially from a known saw blade that includes a cycle of teeth only consisting of one group of teeth having different widths and in which the widest tooth is provided in a double arrangement (two in a row). However, the novel saw blade may include a double arrangement of the teeth of the second group. This means that a first group of teeth is intermixed with two second groups of teeth. It is also possible to irregularly intermix five teeth of a first group with two teeth of a second group.

The number of teeth in the second group should at least be two. Usually, the number of teeth in the first group corresponds to the number of teeth in the second group. It is possible to design the teeth in the first group in a way that they all are subjected to the same stress, and to design the teeth of the second group in a way that they all are subjected to the same stress. The stress of the first teeth may be different from the stress of the second teeth.

It is important to realize that the novel saw blade substantially differs from known precutting and after cutting methods. In this known technology, there are only two different types of teeth, namely the precutting teeth and the after cutting teeth, but no groups of teeth. If one desires to speak of groups of teeth in the known technology, there only is one group consisting of precutting teeth and after cutting teeth. There is no second group of teeth in the cycle. With the novel saw blade, unset teeth of both groups are intermixed. The additional arrangement of set teeth in the cycle is also possible without departing the spirits of the invention, but it does not improve the properties of the saw blade.

The teeth in the first group are not designed as one guiding tooth and a number of following teeth. The teeth in the first group are rather equivalent with respect to the cutting work to be done in a way that all teeth of the first group are subjected to approximately the same forces and moments. The distribution of the effective cutting edges over the cutting edges of the teeth of the first group and their arrangement at a relatively great distance, for example at a distance of at least two pitches, serves to remove chips having a comparatively great thickness.

The present invention may also be used in combination with the known precutting and after cutting technology. For example, there may be the following order of teeth: precutting tooth, widest tooth of the second group of teeth, after cutting tooth, widest tooth of the second group of teeth. In this case, the precutting tooth and the after cutting tooth are phased, whereas the teeth of the second group all do not include phases.

The cutting edges and the cutting edge sections, respectively, of the first and second teeth may be designed and arranged to cut approximately the same chip volume from a cutting channel. In this way, not only the teeth of one group are subjected to the same stress, but all teeth of the saw blade are subjected to a substantially identical cutting force. The chips being removed by the first group of teeth are thicker than the chips being removed by the second group of teeth. On the other hand, the specific cutting force at the teeth of the second group is slightly less since only the chips of the teeth of the first group have two different moving directions due to the phases of the teeth of the first group. When one additionally takes these influences into account, the ratio of the specific cutting forces of the teeth of the first group with respect to the teeth of the second group may be in the range of approximately 1:1 to 1:1.2. Due to the different widths of the chips, the cutting channel in its middle portion is rougher than in its edge portions. In this way the surface quality of the work piece is improved.

However, the cutting edges of the first and second teeth may also be designed and arranged to cut chips having approximately the same width from the cutting channel. In this way, a greater number of chips having the same dimensions are removed from the cutting channel. The intermixed teeth of the second group are subjected to less stress. The effect of the outer tips of the teeth of the second group being rounded stays longer in a good range. The surface quality of the cut work piece is improved. The usable time of the saw blade is increased. Staying within the tolerances during manufacture of the teeth is made easier. The ratio of the specific cutting forces of the teeth of the first group with respect to the teeth of the second group may be in a range of approximately 1:1 to 1:0.6.

It is also possible to leave the above-mentioned ranges, and to consciously work outside these ranges. It may make sense to further relieve the teeth of said second group in a way that the ratio of the specific cutting forces of the teeth of the first group with respect to the teeth of the second group is in a range of approximately 1 to 0.2. The teeth of the second group produce very thin chips. The even lower stress results in an even improved surface quality of the work piece. With this arrangement, the teeth of the first group may be subjected to the same force or to different forces. Chips of the same width being produced by the teeth of the first group result in an approximately identical chip volume and, consequently, in approximately identical specific cutting forces. Chips of different widths being produced by the teeth of the first group result in an unequal chip volume and, consequently, in unequal specific cutting forces. The first tooth of the first group may be designed to remove a smaller chip than the other teeth of the first group. Due to the wedge effect of the first tooth, the saw blade is stabilized, and the straight movement of the saw blade is improved. The other teeth of the first group are subjected to comparatively greater forces, and they fulfill the substantial work of removing chips from the cutting channel. The wanted relieve of these outwardly working teeth may be realized by a double arrangement of the teeth of the second group one after the other.

It is especially preferred when the saw blade only includes unset teeth and when the effective cutting edges and the cutting edge sections, respectively, of all teeth of the first group are formed by an inclined cutting edge. The effective cutting edges of the teeth of the second group are each formed by a continuous effective cutting edge having the shape of a straight line. In this way, each chip being removed by the effective portion of a cutting edge of a tooth of the first group is subjected to a two ways deformation causing the chip to break. This chip breaking effect is not present in the teeth of the second group. However, the chip breaking effect is not necessary for the second group since the second group of teeth is designed and arranged to remove thin chips. An arrangement of phases at all teeth of the first group in a symmetric way with respect to the longitudinal center plane serves to a specifically stabilize the straight movement of the saw blade. A stabilized wedge effect results from a uniform support of the teeth of both groups in the cutting channel in a way that there is no tooth being subjected to a resulting lateral force. Due to the symmetric design and arrangement of the phases at the teeth of the first group, the two lateral forces acting at each tooth of the first group compensate. There are no lateral forces at the teeth of the second group. Consequently, the saw blade does not tend to move in a lateral direction.

Preferably, the teeth of the two groups in the cycle are arranged in a way to be uniformly intermixed. There may also be more than two groups of teeth. The widest tooth in the cycle forming the second group of teeth with its repeated arrangement includes an angle between its cutting edge and its flank of less than 90 degrees. However, the enclosed angle preferably is great enough to prevent wear and tear. It is the outer edge of the teeth that contacts the sidewall of the cutting channel and that determines the improved surface quality. Since the angle between the cutting edge and the flank of the teeth of the second group is just a little less than 90 degrees, wear and tear occurring at the teeth of the second group do not have such a negative effect as it is the case with teeth in which the angle between the cutting edge and the flank is substantially less than 90 degrees. Additionally, the increases number of teeth in the second group also has a positive effect. The usable time of the saw blade and the surface quality of the cutting channel are surprisingly increased. The geometry of the corners of his teeth of the second group effects greater stability in a way to prevent the corners from breaking. This effect is of special importance when hard cutting materials are used.

The present invention may be used with a constant pitch in the cycle. Although the teeth of the first group have a rather similar design, the grading in highs and the grading in widths of the teeth in the first group provides for reduced sensitivity with respect to vibrations and an outstanding straight movement of the stabilized saw blade. However, it is also possible to use the invention in combination with a variable pitch. Due to the application of a variable pitch, the teeth in the first group and the teeth in the second group in their intermixed arrangement form some kind of a third group being present in the cycle several times. In case of the above-described example of three teeth in the first group and three teeth in the second group and when one uses five different pitches, there are 30 teeth in the cycle. Corresponding to the five different pitches, the intermixed arrangement of the teeth repeats five times.

In an especially preferred embodiment of the novel saw blade, one tooth of the second group is arranged between two teeth of the first group. It is also possible to arrange two teeth of the second group between two teeth of the first group. In this way, the “effective pitch” between the teeth of the first group is even increased. This means that the chips get even thicker at a constant feed. On the other hand, the teeth of the second group remove even thinner chips from the faces of the cutting channel.

The first teeth may include phases being located at a phase angle with respect to a line extending perpendicular to the longitudinal center plane of the body. In this way, the phases of the teeth of the first group are arranged to be parallel. Due to the symmetric design of the teeth with respect to the longitudinal center plane of the body, the phases are arranged on the left side and on the right side of the teeth. In case of a uniform grading in heights of the teeth of the first group, there is an equal distance between a first phase and the adjacent phase of the teeth of the first group as seen in the projection and when the point in which the cutting edge starts to be inclined is respectively chosen. When one takes a look at the real surface portions or the real volume portions, the teeth of the first group may be designed to attain an equal surface portion over the teeth or an equal volume portion or distribution over the teeth. However, it is also possible to attain different distances between the phases at the teeth of the first group in the projection even at equal phase angles. On the other hand, the phase angles do not necessarily have to be identical. The number of points of inclination being located in an effective, inclined cutting edge portion may be more than one. The teeth of the second group all have the same design. Each tooth of the second group has approximately the same height, approximately the same width and approximately the same design of the continuous, straight cutting edge including no points of inclination. The teeth of the second group may have a rounded design towards the outside to make them especially insensitive against wear and tear, and to further reduce the roughness of the finished surface in the cutting channel.

Preferably, at least the teeth of the second group have a greater width than the body. However, the teeth of the first group may at least be partially wider than the body. In this way, a free cut is attained.

The flanks of the teeth of the second group may be arranged at a flank angle in a range between approximately three degrees and twelve degrees, and especially of approximately eight degrees. A small flank angle results in a stable design of the free corners of the teeth of the second group. This fact does not have great importance to the teeth of the first group since their corners do not cut due to the comparatively less widths of the teeth of the first group. It is also possible to design the flanks of all teeth of both groups to have an identical flank angle in a way that they cover in the projection. This covering arrangement simplifies the manufacture of the saw blade by making it possible to machine the flanks of the teeth of all groups without having to change the adjustment of the machine. For example, the flanks are machined by grinding.

The fist and second teeth may include a ground hard metal element. In combination with the phase angle of the teeth of the first group, an additional grading in widths occurs. The teeth of both groups all have a large area design to be fully subjectable to stress. Usually, the teeth of the two groups and essential portions thereof, respectively, are made of hard metal being connected to the body of the saw blade and by following grinding. It is to be understood that the elongated, band-like element of the body is first produced by milling, punching or grinding. It is also possible to use a profiled rod or a bimetal strip that has been rolled to enlarge conically to one side as the material for the body, and to form the teeth of both groups by punching, milling and/or grinding.

There may be groups having a repeating variable pitch in the recurring cycle of teeth of the two groups of teeth. The number of teeth in the divisional group does not necessarily have to be identical with the number of teeth in the two other groups. In case of a divisional group including five different pitches, a first group including three first teeth and a second group including three second teeth, the number of teeth in the cycle is 30. The number of teeth in the cycle equals the smallest common multiple of the pitches and of the number of teeth of the two intermixed groups of teeth. Due to this comparatively great number of teeth in the cycle, the saw blade is rather insensitive with respect to vibrations. The novel saw blade has a great smoothness of running, a stabilized straight movement and the usable time is surprisingly increased compared to known saw blades. The number of teeth in the additional group being determined by the series of variable pitches may be identical with the number of teeth of the two other groups. In this case, the number of teeth in the cycle is especially great, and the saw blade runs with great smoothness. However, it is also possible that the number of teeth in the additional group corresponds to the number of teeth in the cycle, as it corresponds to the number of variable pitches in the series.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is an enlarged side view of a section of a novel saw blade.

FIG. 2 is a top view of the saw blade of FIG. 1.

FIG. 3 is a side view of a band saw blade including two first teeth in a first group and two second teeth in a second group having the same chip volume along line III-III in FIG. 1.

FIG. 4 is a similar view as FIG. 3, but it illustrates a different exemplary embodiment of a saw blade, the chips having the same width.

FIG. 5 is a is a similar view as FIG. 4, but it illustrates another exemplary embodiment of a band saw blade including three first teeth in a first group and three second teeth in a second group, the chips having the same width.

FIG. 6 is a similar view as FIG. 4, but it illustrates another exemplary embodiment of a band saw blade including four first teeth in a first group and four second teeth in a second group, the chips having the same width.

FIG. 7 is a similar view as FIGS. 3 or 4, but it illustrates another exemplary embodiment of a band saw blade including two first teeth in a first group and two second teeth in a second group, the chips of the teeth of the respective groups having different widths.

FIG. 8 is a similar view as FIGS. 3 or 4, but it illustrates another exemplary embodiment of a band saw blade including two first teeth in a first group and two second teeth in a second group, the chips of the teeth of the first group having different widths.

### DETAILED DESCRIPTION

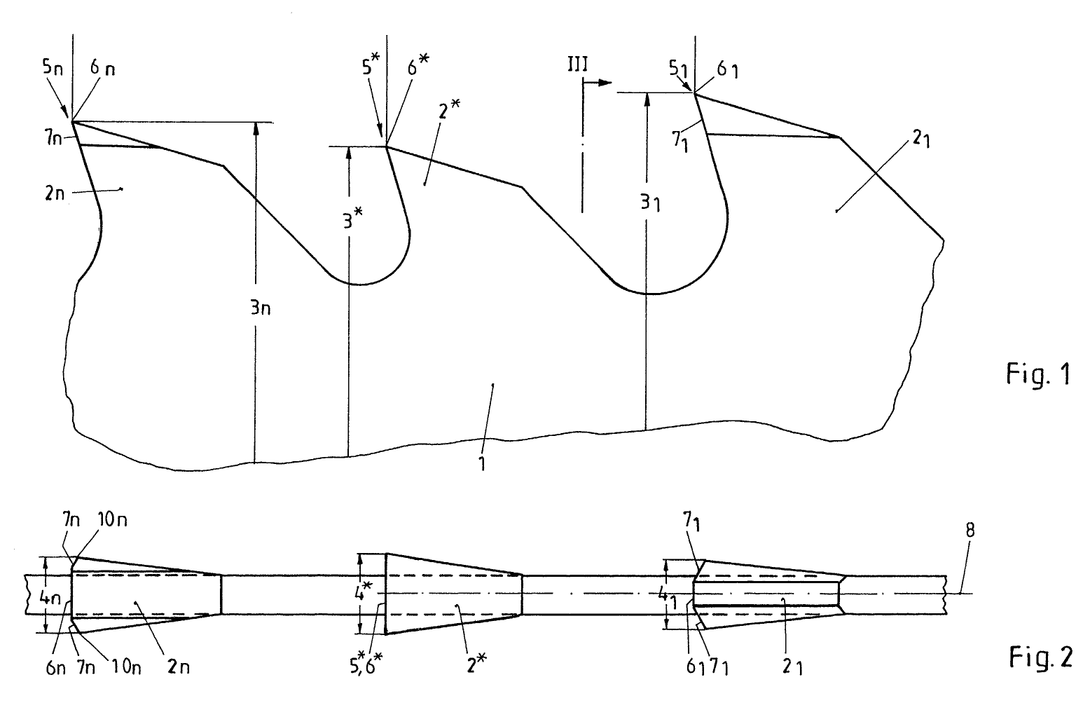

Referring now in greater detail to the drawings, FIG. 1 illustrates a section of a band saw blade including a body 1 having an elongated edge portion and unset first teeth 2 and unset second teeth 2* being spaced apart and formed symmetrically along the elongated edge portion. The teeth 2, 2* are arranged at the body 1 in recurring or repeating cycles. A first group includes first teeth 2 having different heights and widths. The highest first tooth 2₁ of such a first group is designated by the index “1” while the smallest first tooth 2ₙ of such a first group of teeth is designated by the index “n”. A second group includes teeth 2* having approximately the same height and width. The height of the tooth 2* is less than the height of the smallest tooth 2ₙ of the first group. The tooth 2* of the second group is wider than the widest tooth 2 of the first group.

For reasons of simplifying the understanding of the invention, it is now assumed that the number of teeth in each cycle equals the sum of the number of first teeth 2 of the first group plus the number of second teeth 2* of the second group, as it is the case with an equal pitch. The number of first teeth 2 in the first group is at least two, but it may also be more than two. The number of second teeth 2* in the second group is at least two, but it preferably is identical to the number of first teeth 2 in the first group. Each tooth 2, 2* has a height 3, 3* again being designated by the indexes as explained hereinbefore. In the illustrated embodiment, the teeth 2 in the first group are graded in heights in a way that each height 3 of a tooth 2 is less than the height 3 of the respective adjacent tooth 2. Accordingly, the height 3₁ of the tooth 2₁ of the first group is more than the height 3₂ of the tooth 2₂ of the first group, the height 3₂ of the tooth 2₂ of the first group is more than the height 3₃ of the tooth 2₃ of the first group and so forth. Consequently, the last tooth 2ₙ of the first group has the smallest height of all teeth 2 in the first group, but it is still more than the height 3* of the second teeth 2* of the second group. However, the order of the first teeth 2 of the first group in the direction of the movement of the band saw blade may also be different. The variety of different possible arrangements of the first teeth will be explained by way of example hereinbelow.

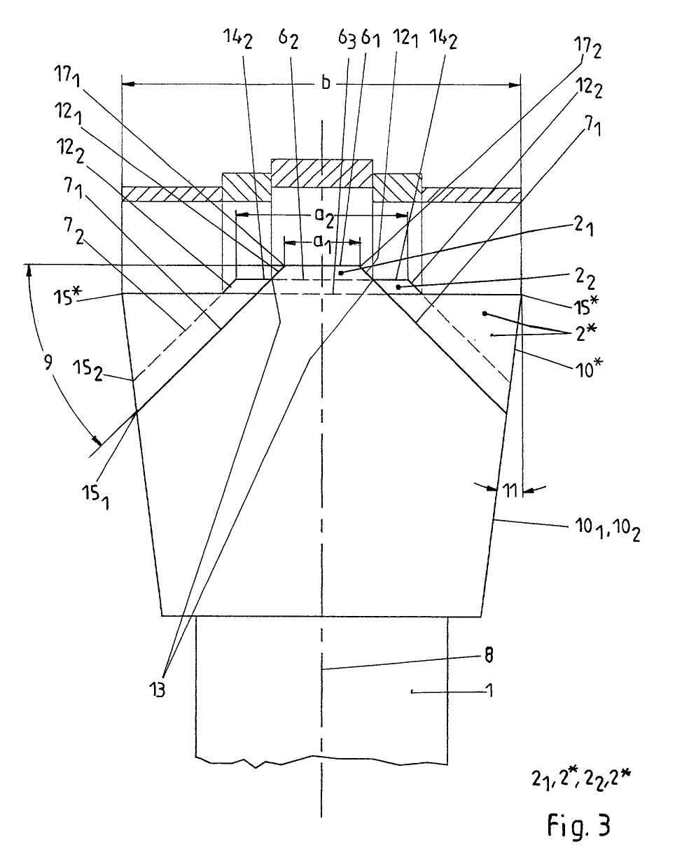

The teeth 2 of the first group also have different widths 4, and they are graded in widths in a way that the first tooth 2₁ of the first group has the smallest width and that the last tooth 2ₙ of the first group has the greatest width of all teeth 2 within in the first group. However, the tooth 2* of the second group is still wider than the last tooth 2ₙ of the first group. Each tooth 2 of the first group includes an inclined cutting edge 5 being formed by an inner section 6 and two phases 7 being connected to the outer portions of the inner section 6. The sections 6 extend perpendicular with respect to a longitudinal center plane 8 extending through the body 1. The design of each tooth 2 is symmetric with respect to the longitudinal center plane 8 in a way that the phases 7 are symmetrically located at the right side and at the left side of each tooth 2. As it is especially to be seen from the projections of FIGS. 3 to 6, the phases 7 are arranged to be inclined with respect to the body 1. All teeth 2 include a phase angle 9 of between approximately 20 degrees and 60 degrees. Preferably, the phase angle 9 is approximately 45 degrees. The phase angle 9 is defined as the angle between a direction perpendicular to the longitudinal center plane 8 and the phase 7. The phases 7 are only provided at the teeth 2 of the first group in a way that the phase 7 of the first and highest tooth 2₁ only has a comparatively small section 6₁ having a length being less than the thickness of the body 1 (see FIG. 3). The teeth 2* of the second group all have the same design and effects. In case of an equal pitch, but they are equally spaced apart. Preferably, the teeth 2* are located between the first teeth 2 of the first group. The teeth 2* of the second group include a cutting edge extending continuously and straight over its width (see FIG. 2). Only the portions of the cutting edges of the teeth 2* of the second group not being covered by the projections on the teeth 2 are effective. This means that only in these portions take chips out from the cutting channel. The teeth 2* of the second group define the quality of the surface of the cut work piece.

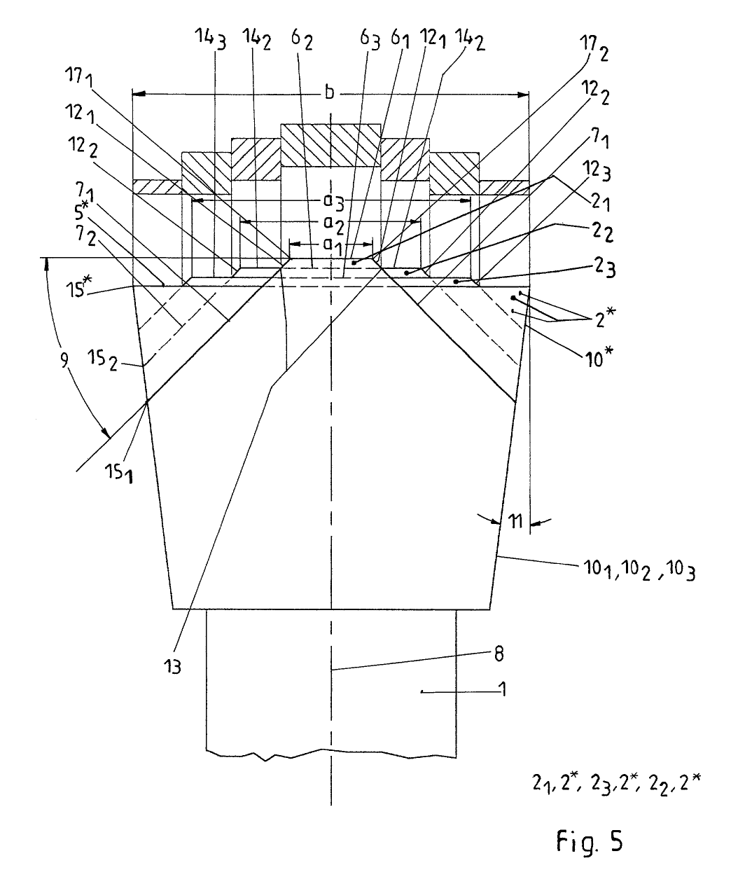

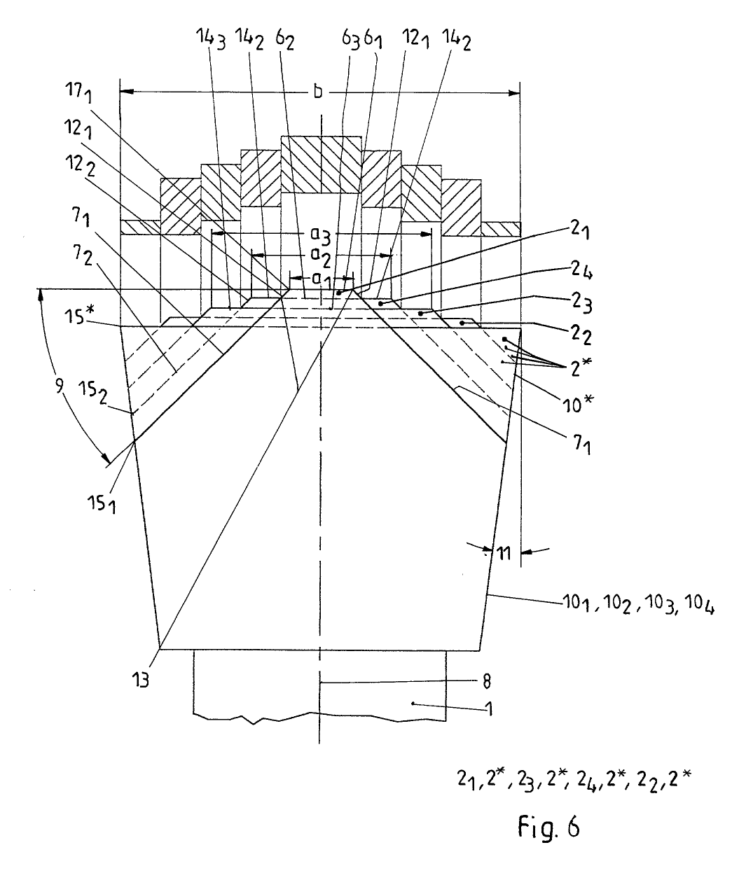

The different possible designs of the novel band saw blade are to be best seen from FIG. 3 illustrating an exemplary embodiment of the saw blade including two first teeth 2 in the first group and to second teeth 2* in the second group. The four teeth 2, 2* in the cycle are arranged in the order 2₁, 2*, 2₂, 2* as seen from the front to the rear. Only in case of two teeth 2 in the first group and two teeth 2* of the second group being regularly located therebetween, there is no variation of the arrangement of the teeth in the running direction of the band saw blade since the beginning of a cycle or the beginning of a group of teeth may be freely chosen along the band saw blade. This is different in case of more than two teeth being part of the first group, as this is to be seen from FIGS. 5 and 6. It is to be seen from the front view of FIG. 1 that the highest tooth 2₁ of the first group has a comparatively small section 6₁ having a length a₁. The comparatively long phases 7₁ are connected to both sides of the straight section 6₁ at a phase angle 9 of approximately 45 degrees. The phase 7₁ extends to the flank 10₁ of the tooth 2₁. Coming from the body 1, the flank 10₁ widens in the direction towards the tip of each tooth 2, 2*. In the illustrated exemplary embodiment of FIG. 3, the flank 10₁ is located at a flank angle 11 approximately eight degrees. The flank angle 11 is not designated by an index since the flanks 10 of all teeth 2, 2* of both groups fall together in the projection of FIG. 3. This means that all flanks 10 are located at the same flank angle 11. The flanks 10 are produced by a grinding process over all teeth 2, 2* of the two groups. However, the highest tooth 2₁ of the first group only cuts with the portion of its cutting edge 5₁ in the projection protruding over the outline of the tooth 5₂ of the first group being located behind the first tooth 2* of the second group. The effective portion of the cutting edge 5₁ of the tooth 2₁ in the first group, meaning the portion that effectively cuts the work piece, is formed by the straight portion 6₁ and the sections 12₁ being connected to both sides of the straight section 6₁. The sections 12₁ end in the projection cutting point 13.

The highest tooth 2₁ of the first group is followed by a tooth 2* of the second group. The tooth 2* of the second group has a height being less than the heights of the first teeth 2₁ and 2₂ of the first group, but it is wider than the teeth 2₁ and 2₂ of the second group.

The second highest tooth 2₂ of the first group is the third tooth in the cycle. The tooth 2₂ includes a straight section 6₂ of a length a₂. The phases 7₂ are connected to both sides of the straight section 6₂ in a symmetric fashion. The phases 7 being located at the first teeth 2 of the first group have a parallel design. Only part of the tooth 2₂ cuts the work piece. It is the portion of the cutting edge 5₂ protruding beyond the outline of the other teeth 2, 2*. These are the two cutting edge sections 14₂ of the section 6₂ extending perpendicular to the longitudinal center plane 8 and the respective adjacent sections 12₂ of the phases 7₂. When one imaginarily extends the flanks 10 in a direction towards a line being the thought extension of the section 6₁, a theoretical width b of the teeth 2, 2* results.

It is to be seen from FIG. 3 that only the two outer corners 15* of the second teeth 2 of the second group cut, whereas the edges 15₁ and 15₂ of the first teeth 2 of the first group move inside the cutting channel. Consequently, they do not participate in cutting the work piece. With respect to the usable time of the saw blade and the unpreventable wear and tear occurring at the corners 15*, it is essential to realize that the smaller angle between the cutting edge 5* and the flank 10* preferably is only a little less than 90 degrees.

In is also to be seen from FIG. 3 that the teeth are uniformly graded in height. This applies both to the teeth 2 of the first group and to the teeth 2* of the second group. However, the teeth 2, 2* are not uniformly graded in width. The grading in height and the grading in width are chosen in combination with the phase angle 9 in a way that strip-like portions (chips) are taken from the cutting channel being formed in the work piece. The volume of the strips and of the chips, respectively, is approximately the same for the teeth 2, 2*, but the thickness of the strips is different. Thus, the teeth 2, 2* of both groups are subjected to approximately the same forces and moments. The second teeth 2* of the second group take chips out off the cutting channel being approximately half as thick as the chips being taking out off the cutting channel by the first teeth 2 of the first group. The height of the strips corresponds to the highs of the teeth 2₁ and 2₂ taking the feed into account. Consequently, a relatively thick ship is taken out off the cutting channel by the first teeth 2 of the first group. The heights of the strip-like portions of the teeth 2* are respectively thinner. It is imaginable that two smaller strips are removed by the teeth 2* during the same time interval during which one bigger strip is being removed by the teeth 2 of the first group. Each single chip that is removed by a tooth 2 of the first group is being bent into two different directions in the region of the inflection point 17 of the cutting edge between the straight portion 6 and the effective portion of the phase 7. This arrangement contributes to splitting up the individual chips further during removal.

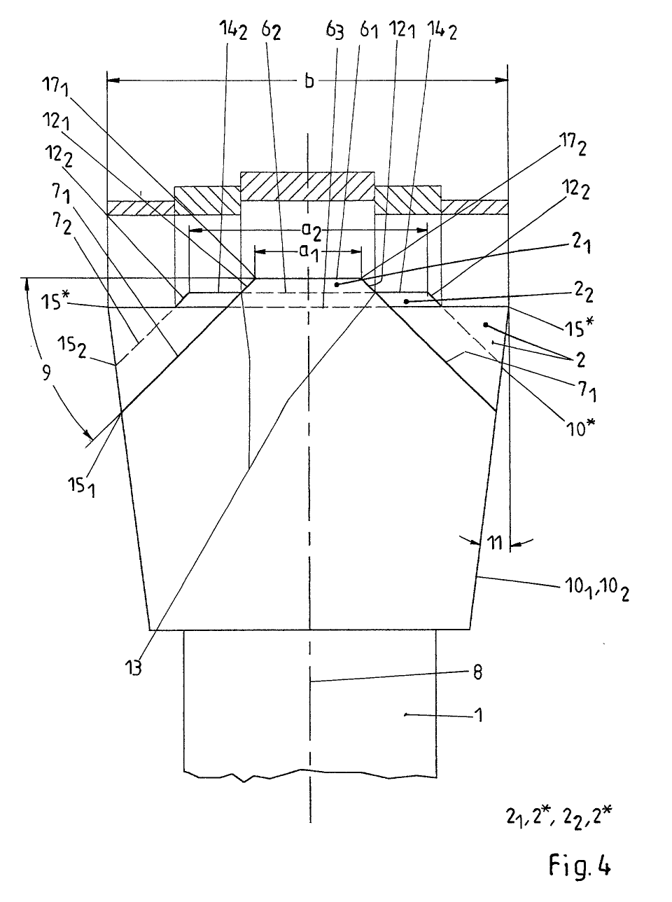

The embodiment of the saw blade of FIG. 4 is similar to the one of FIG. 3. However, it is not desired to subject the teeth 2, 2* to approximately identical forces, but rather to produce chips having the same width. In this way, the teeth 2* of the second group are subjected to a smaller force than the teeth 2 and the surface quality of the cut work piece and the usable time of the saw blade are increased. With respect to other features of the saw blade being illustrated in FIG. 4, it is referred to the description of the saw blade of FIG. 3.

The phase angle 9 may be approximately 30 degrees. However, it is also possible to choose a different phase angle 9, for example of approximately 45 degrees. Usually, the phase angles 9 of the teeth 2 of the first group are identical. The straight sections of the cutting edges may be arranged slightly inclined with respect to the longitudinal center plane without departing from the symmetrical design.

In the embodiment of the saw blade as illustrated in FIG. 5, the first group includes three teeth 2 between which a tooth 2* of the second group is located. Assuming that a constant pitch is used, the number of teeth 2, 2* in one cycle is six. The grading of heights and the grading of widths are both realized uniformly over the teeth 2, 2* of both groups. When the first group consists of three teeth 2, as illustrated, there are two possible arrangements of the teeth 2, 2* on the saw blade. The first possibility of arranging the teeth is the order 2₁, 2*, 2₂, 2*, 2₃, 2*. The second illustrated possibility is the order 2₁, 2*, 2₃, 2*, 2₂, 2*. FIG. 5 illustrates a design and arrangement of the teeth 2, 2* for producing chips of the same effective width. It is imaginable that the teeth 2, 2* may also be designed and arranged to realize an identical chip volume, and the teeth 2, 2* being subjected to approximately identical forces, respectively, as this has been described with respect to the embodiment of the saw blade of FIG. 3.

However, it is also possible to arrange the second teeth 2* of the second group at one or more places in the cycle in a double arrangement. For example, there may be the following orders of teeth 2, 2*:

2₁, 2*, 2₂, 2*, 2*, 2₃, 2*; or

2₁, 2*, 2₃, 2*, 2₂, 2*, 2*; or

2₁, 2*, 2*, 2₃, 2*, 2*, 2₂, 2*, 2* and so forth.

In a first exemplary embodiment of the saw blade as illustrated in FIG. 6, there are four teeth 2 in the first group. A tooth 2* of the second group is located between each of the adjacent teeth 2. Still assuming that a constant pitch is used, the number of teeth in the cycle is eight. The grading of heights and the grading of widths are both realized uniformly over the teeth 2, 2* of both groups. When the first group consists of four first teeth 2, as illustrated, there are six possible arrangements of the teeth 2, 2* on the saw blade:

2₁, 2*, 2₂, 2*, 2₃, 2*, 2₄, 2*;

2₁, 2*, 2₂, 2*, 2₄, 2*, 2₃, 2*;

2₁, 2*, 2₃, 2*, 2₂, 2*, 2₄, 2*;

2₁, 2*, 2₃, 2*, 2₄, 2*, 2₂, 2* (as illustrated in FIG. 6);

2₁, 2*, 2₄, 2*, 2₂, 2*, 2₃, 2*; and

2₁, 2*, 2₄, 2*, 2₃, 2*, 2₂, 2*.

All this is true when taking into account that it is not important at which position on the band saw blade a group or a cycle starts. In the first described possible arrangement, the teeth 2 of the first group are arranged in a way that their heights decrease in the running direction of the band saw blade. In the sixth possible arrangement, the teeth 2 of the first group are arranged in a way that there heights increase in the running direction of the band saw blade. In other words, their heights decrease in a direction opposite the running direction of the band saw blade. FIG. 6 illustrates the design and arrangement of the teeth 2, 2* for producing identical effective chip widths. It is imaginable that the teeth 2, 2* may also be designed and arranged to realize an identical chip volume, and the teeth 2, 2* being subjected to approximately identical forces, respectively, as this has been described with respect to the embodiment of the saw blade of FIG. 3.

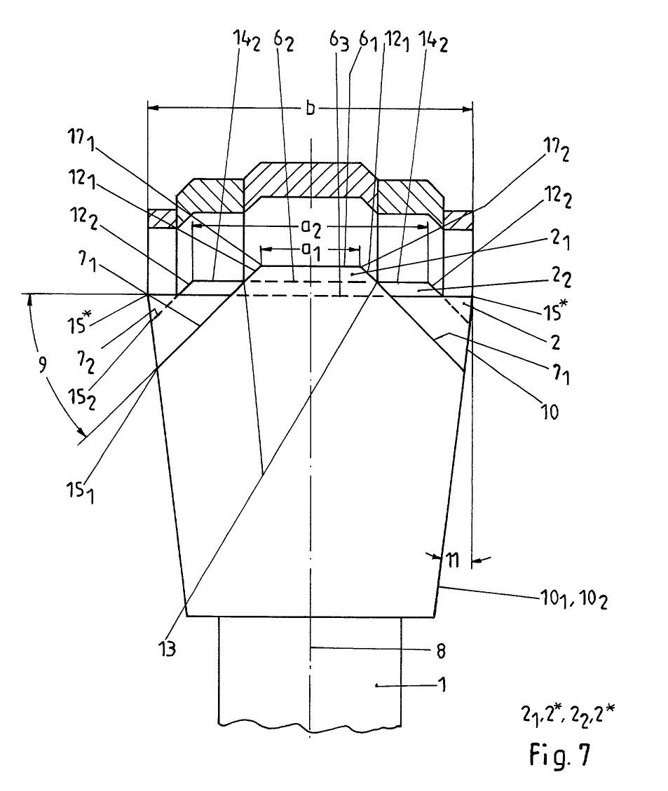

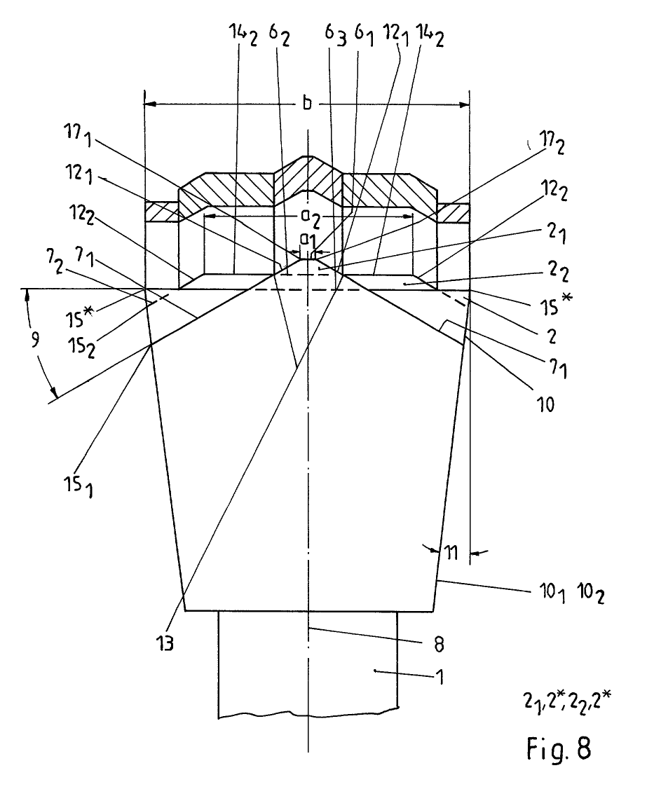

However, other ways of arranging the teeth 2 of the first group and the teeth 2* of the second group with respect to one another and within each group are also possible. Two of these additional possibilities are illustrated in FIGS. 7 and 8. FIGS. 7 and 8 only show four teeth in a group, as this has already been explained with respect to FIGS. 3 and 4. However, the use of more than four teeth in a group is possible, and it is understandable when taking into account the strategies that have been explained with respect to FIGS. 5 and 6.

With respect to the general description of FIGS. 7 and 8, it is referred to the above-described exemplary embodiments of the band saw blade. FIGS. 7 and 8 utilize the same reference numerals that have already been used in FIGS. 3 and 4. Different from the illustrations of FIGS. 3 and 4, the removed chip volume is not illustrated as rectangles (as it is the case in FIGS. 3 is to 6), but rather more realistic as it results from the inclined phases of the teeth 2 of the first group. From this inclined illustration, the two directions of movement of the material of the respective elements of material of a chip of a tooth 2 of the first group are to be seen.

FIG. 7 illustrates an exemplary embodiment of the saw blade in which the teeth 2 of the first group of teeth all have the same design, but in which they are subjected to substantially greater forces and moments than the teeth 2* of the second group. The ratio of the cutting forces being effective at the teeth 2 of the first group with respect to the cutting forces being effective at the teeth 2* of the second group may be approximately 1:0.2. The tooth 2* of the second group being located between two teeth 2 of the first group is not subjected to great forces, on the one hand, and it only removes a narrow chip from the cutting channel, on the other hand. With this arrangement, the teeth 2 of the first group fulfill the substantial work of removing chips from the work piece to be cut, while the teeth 2* of the second group provide for great surface quality of the cut work pieces. Due to the reduced stress subjecting the teeth 2* of the second group, the undesired process of the outer corners of the teeth 2* being rounded is retarded. This means that wear and tear have a value that still allows for great surface quality during long term use of the saw blade. Additionally, the usable time of the saw blade is increased.

The exemplary embodiment of the saw blade of FIG. 8 again relates to the lowest possible number of teeth in the cycle. The teeth 2 of the first group have different designs compared to one another in a way that they all have different widths. Consequently the chip volumes are different and the stress or load of the teeth 2 is different. The highest tooth 2₁ of the first group is mainly designed to provide a wedge effect. The tooth 2₁ stabilizes the straight movement of the saw blade. The following second tooth 2₂ of the first group mainly serves to remove chips. Due to their numerous arrangements in the cycle, the teeth 2* of the second group remove comparatively smaller and thinner chips from the cutting channel. Due to the fact that the teeth 2* of the second group do not include a phase, there only is one flowing direction of the materiel. Consequently, the stress of the teeth 2* of the second group is chosen to be low to ensure a long usable time of the saw blade and great surface quality of the cut work piece. The ratio of the specific cutting forces of the first tooth 2 of the first group with respect to the second tooth 2 of the first group and with respect to the teeth 2* of the second group may be in a range of approximately 1.0:2.0:0.5. For example, this may be 40 kg:80 kg:20 kg.

Although the above-described exemplary embodiments of the novel saw blade show a constant pitch, it is easily imaginable that a variable pitch may be used without departing from the principles of the invention. In case of a variable pitch, the number of teeth in the first group is different from the number of teeth in the cycle. It is also possible to have teeth of varying grading in heights. It is also possible to arrange additional teeth. For example, the teeth 2* of the second group may be placed in a double arrangement between the teeth 2 of the first group.

Many variations and modifications may be made to the preferred embodiments of the invention without departing substantially from the spirit and principles of the invention. All such modifications and variations are intended to be included herein within the scope of the present invention, as defined by the following claims.

We claim:

1. A saw blade, comprising:
a body being formed approximately symmetrically about a longitudinal center plane; and
a plurality of spaced apart unset teeth being formed approximately symmetrically along the longitudinal center plane of said body in at least one recurring cycle of teeth,
said at least one recurring cycle of teeth including at least one first group of teeth and at least one second group of teeth,
said at least one first group of teeth including at least two first teeth each having a height and a width, the height of one first tooth being different than the height of one other first tooth and the width of one first tooth being different than the width of one other first tooth, said at least two first teeth each including at least one effective cutting edge having at least one phase,
said at least one second group of teeth including at least two second teeth each having a height and a width, the height of said second teeth being approximately identical and the width of said second teeth being approximately identical, the height of said second teeth being less than the smallest height of said first teeth and the width of said second teeth being more than the greatest width of said first teeth, said at least two second teeth each including one effective cutting edge having a width and being designed to be continuous and straight along its width.

2. The saw blade of claim 1, wherein said cutting edges of said first and second teeth are designed and arranged to cut approximately the same chip volume from a cutting channel of a work piece to be cut.

3. The saw blade of claim 1, wherein said cutting edges of said first and second teeth are designed and arranged to cut chips having approximately the same width from a cutting channel of a work piece to be cut.

4. The saw blade of claim 1, wherein all of said first and second teeth are unset.

5. The saw blade of claim 1, wherein at least one second tooth is arranged between two adjacent first teeth.

6. The saw blade of claim 1, wherein each of said second teeth includes a flank being arranged at an angle of less than 90 degrees with respect said cutting edge.

7. The saw blade of claim 1, wherein said phase of each of said first teeth is located at a phase angle with respect to a line extending perpendicular to the longitudinal center plane.

8. The saw blade of claim 7, wherein the phase angles of said first teeth are approximately identical.

9. The saw blade of claim 6, wherein said second teeth of said second group have a round design between said cutting edge and said flank.

10. The saw blade of claim 1, wherein at least said second teeth of said second group have a width being more than the width of said body.

11. The saw blade of claim 6, wherein said flanks of said second teeth of said second group are arranged at a flank angle of between approximately 3 degrees and 12 degrees.

12. The saw blade of claim 6, wherein said flanks of said second teeth of said second group are arranged at a flank angle of approximately 8 degrees.

13. The saw blade of claim 1, wherein said first and second teeth include a ground hard metal element.

14. The saw blade of claim 1, further including a plurality of additional groups of teeth having a recurring, variable pitch.

15. The saw blade of claim 14, wherein the number of teeth in said additional groups of teeth is not identical to the number of teeth in said first and second group.

16. A saw blade, comprising:
a body including an elongated edge portion and being formed approximately symmetrically about a longitudinal center plane; and
a plurality of spaced apart unset teeth being formed approximately symmetrically along said elongated edge portion and along the longitudinal center plane of said body in at least one recurring cycle of teeth,
said recurring cycle of teeth including at least one first group of teeth and at least one second group of teeth,
said first group of teeth including at least two unset first teeth each having a height and a width, the heights of said first teeth being different and the widths of said first teeth being different, said first teeth including at least one effective cutting edge having at least one phase,
said second group of teeth including at least two unset second teeth each having a height and a width, the heights of said second teeth being approximately identical and the widths of said second teeth being approximately identical, the height of said second teeth being less than the heights of said first teeth and the width of said second teeth being more than the widths of said first teeth, said second teeth each including one effective cutting edge having a width and being designed to be continuous and straight along its width.

17. The saw blade of claim 16, wherein said first teeth of said first group and said second teeth of said second group are connected to said body in an uniformly intermixed arrangement.

18. The saw blade of claim 16, wherein said second teeth are arranged between two adjacent first teeth.

19. The saw blade of claim 16, wherein at least said second teeth have a width being more than the width of said body.

20. The saw blade of claim 16, wherein said saw blade is designed as a band saw blade.
